(19) United States
(12) Patent Application Publication
(10) Pub. No.: US 2018/0237350 A1
(43) Pub. Date: Aug. 23, 2018

(54) ARTIFICIAL SOILS AND METHODS FOR MANUFACTURING ARTIFICIAL SOILS

(71) Applicant: Utter Technology, LLC, Bethel, OH (US)

(72) Inventor: Terry D. Utter, Bethel, OH (US)

(21) Appl. No.: 15/902,330

(22) Filed: Feb. 22, 2018

Related U.S. Application Data
(60) Provisional application No. 62/462,139, filed on Feb. 22, 2017.

(51) Int. Cl. C05D 3/02; C05G 3/04; C09K 17/02; C09K 17/06

(52) U.S. Cl. CPC C05D 3/02; C09K 17/06; C09K 17/02; C05G 3/04

(57) ABSTRACT

An artificial soil for growing vegetation includes a mixture of biosolids from a wastewater treatment plant, at least one of synthetic gypsum and a gypsum-depleted by-product, and a calcium compound from at least one of a lime kiln dust, a fluidized bed ash, and a ball mill lime. The calcium compound is present in an amount sufficient to heat the mixture to at least about 132° F. following mixing. The mixture may include at least one of silica and alumina. The artificial soil may include hydrated lime. The mixture may include at least about 1/9 by volume of biosolids and/or from about ⅛ to about ½ by volume of the calcium compound. A method of manufacturing the artificial soil includes mixing biosolids with at least one of synthetic gypsum and a gypsum-depleted by-product and at least one of a lime kiln dust, a fluidized bed ash, and a ball mill lime.

### CROSS REFERENCE TO RELATED APPLICATIONS

This application claims the benefit of U.S. Provisional Patent Application Ser. No. 62/462,139 filed on Feb. 22, 2017, the disclosure of which is expressly incorporated by reference herein in its entirety.

### FIELD OF THE INVENTION

This invention relates to soils, particularly artificial soils, and methods for manufacturing artificial soils.

### BACKGROUND OF THE INVENTION

Topsoil degradation and loss continue to be significant problems. Topsoil is the topmost layer of soil that supports plant growth and is therefore essential to supporting life on the Earth. Despite its importance, it is estimated that the United States is losing topsoil 10 times faster than a replenishment rate, which is the rate at which topsoil is produced naturally. Other industrialized countries are losing topsoil at even more frightening rates. For example, topsoil loss rates in China are estimated to be 40 times faster than the replenishment rate. As a result, more land is becoming more unproductive as the nutrients in the topsoil are depleted or the topsoil is lost altogether. When combined with an increase in demand for agricultural products as the population of the Earth grows, topsoil degradation and loss become even more worrisome.

Topsoil loss may be through erosion by water and by wind. It is thought that the topsoil carried away by erosion is ultimately discharged into the oceans of the world and is not recoverable. Other causes of topsoil loss may include strip mining and earthworks, such as road construction. In each, the topsoil may be stripped away or the topsoil is left exposed and is lost through erosion.

In the agricultural industry, farmers have developed no-till agricultural techniques by which seeds are planted without tilling the topsoil. These types of techniques reduce topsoil loss by leaving residual roots and debris from a previous year's planting in place. The untilled roots and debris form a layer of cohesiveness which binds the topsoil in place and thereby resists erosion. However, no-till techniques only slow down topsoil loss. And, the problems do not end with only topsoil loss.

Degradation of topsoil may be by overproduction by which the soil is depleted of essential nutrients. This is one reason that fertilizers are used, that is to replace essential nutrients for plant growth, which are often crops. Fertilizers may be in liquid or solid form and may be distributed on the soil prior to or following planting. While the fertilizers provide essential nutrients, such as nitrogen and phosphorus, other nutrients may be beneficial for plant growth. These may include potassium-containing compounds and calcium-containing compounds that modify the pH in the soil.

Commercial fertilizers often require significant energy in their production. Other less energy-intensive fertilizers include organic-based fertilizers from animals, including humans, in the form of feces and urine. These organic-sourced fertilizers are plentiful and cheap. In many developed countries, industry, hospitals, and households produce human feces and urine that are mixed with water and are centrally collected at a wastewater treatment plant. So, they are available in bulk.

A process at the wastewater treatment plant removes much of the contaminants (i.e., bio, organic, and inorganic contaminants) from the water. The solids, including feces, are commonly referred to as sewage sludge and may also be referred to as biosolids. The treated water is discharged from the wastewater treatment plant as an effluent. The biosolids are then further treated or are disposed of via landfill or incineration.

Treatment of the biosolids may further remove contaminants. However, fecal coliform bacteria and other bacteria may remain in the treated biosolids. This problem may be exclusive to human originated biosolids. While not directly harmful to human health, the presence of fecal coliform bacteria in water may indicate the presence of pathogens that are directly harmful to human health. Human originated biosolids may be tested to determine whether they present a danger for use as fertilizer.

In the U.S., biosolids from treatment plants may be rated by the level of fecal coliform bacteria present in accordance with 40 C.F.R. § 503. These classifications are referred to as Class A Biosolids and Class B Biosolids. Class A Biosolids have a lower level of fecal coliform bacteria than Class B Biosolids. According to that regulation, Class B Biosolids are limited in use and may be applied only to land utilized to grow fodder. Class A Biosolids are not restricted as to their application and so may be used to grow crops for human consumption.

While available, these classes of biosolids are not a replacement for topsoil but may be applied as a fertilizer to enhance the available essential nutrients of degraded topsoil. Moreover, there are other problems with use of these biosolids. For one, they may not be indiscriminately applied to land with existing plants. Direct contact with plants may destroy them. In addition, extensive application of biosolids followed by precipitation may wash the biosolids into nearby water sources and so may contaminate local drinking water.

Instead, human originated biosolids are often applied prior to plant growth, are worked into the soil, or are diluted prior to application. As a result of possible bacterial contamination and the difficulties and timing of application of biosolids, large quantities of biosolids are left unused. This resource is often landfilled or incinerated as a result.

There remains a need for reducing topsoil degradation and loss and for providing a viable alternative to topsoil that aids vegetation growth and crop production.

### SUMMARY

The present invention overcomes the foregoing and other shortcomings and drawbacks of human originated biosolids heretofore known for growing vegetation. While the invention will be described in connection with certain embodiments, it will be understood that the invention is not limited to these embodiments. On the contrary, the invention includes all alternatives, modifications and equivalents as may be included within the spirit and scope of the present invention.

In accordance with the principles of the present invention an artificial soil for growing vegetation comprises a mixture of biosolids from a wastewater treatment plant, at least one of synthetic gypsum and a gypsum-depleted by-product from a process that produces gypsum separately from the gypsum-depleted by-product, and a calcium compound from at least one of a lime kiln dust, a fluidized bed ash, and a ball mill lime.

In one embodiment, the at least one of the lime kiln dust, the fluidized bed ash, and the ball mill lime is present in an amount sufficient to heat the mixture to at least about 132° F. following mixing.

In one embodiment, the mixture further includes at least one of silica and alumina. In one embodiment, the at least one of silica and alumina is from the one of the lime kiln dust, the fluidized bed ash, and the ball mill lime. In one embodiment, the artificial soil further includes hydrated lime.

In one embodiment, the gypsum-depleted by-product is from a process that produces the synthetic gypsum.

In one embodiment, the mixture includes at least about 1/9 by volume of biosolids.

In one embodiment, the mixture includes from about ⅛ to about ½ by volume of the calcium compound.

In accordance with the principles of the present invention, a method of manufacturing an artificial soil comprises mixing biosolids from a wastewater treatment plant with at least one of synthetic gypsum and a gypsum-depleted by-product from a process that produces gypsum separately from the gypsum-depleted by-product and at least one of a lime kiln dust, a fluidized bed ash, and a ball mill lime.

In one embodiment, during mixing, the at least one of the lime kiln dust, the fluidized bed ash, and the ball mill lime is added in an amount sufficient to heat the mixture to at least about 132° F.

In one embodiment, mixing further includes mixing hydrated lime with the biosolids.

In one embodiment, mixing the at least one of the gypsum and gypsum-depleted by-product with the biosolids is prior to mixing the biosolids with the at least one of the lime kiln dust, the fluidized bed ash, and the ball mill lime.

In one embodiment, the gypsum-depleted by-product is from a process that produces the synthetic gypsum.

In one embodiment, prior to mixing, the method comprises adding about 50 vol. % biosolids to about 50 vol. % of the synthetic gypsum.

In one embodiment, mixing includes adding from about 1/9 to about ½ by volume of the at least one of the lime kiln dust, the fluidized bed ash, and the ball mill lime in the mixture.

In one embodiment, mixing includes adding at least one of silica and alumina.

In one embodiment, addition of the at least one of silica and alumina is included in the at least one of the lime kiln dust, the fluidized bed ash, and the ball mill lime.

### BRIEF DESCRIPTION OF THE DRAWINGS

The accompanying drawings, which are incorporated in and constitute a part of this specification, illustrate embodiments of the invention and, together with a general description of the invention given above, and the detailed description of the embodiments given below, explain the principles of the invention.

FIG. 1 is a schematic representation of an artificial soil manufacturing process;

FIG. 2 is a perspective view of artificial soil according to one embodiment of the present invention;

FIG. 3 is a schematic representation of a flue gas desulfurization process;

FIGS. 4-15 are photographs of mixtures according to Examples described herein;

FIGS. 16A-16J are exemplary analytical results for a synthetic gypsum according to embodiments of the invention;

FIG. 17 are exemplary compositions of limestone sand; and

FIG. 18 includes a list of additional data regarding a fluidized bed ash.

### DETAILED DESCRIPTION

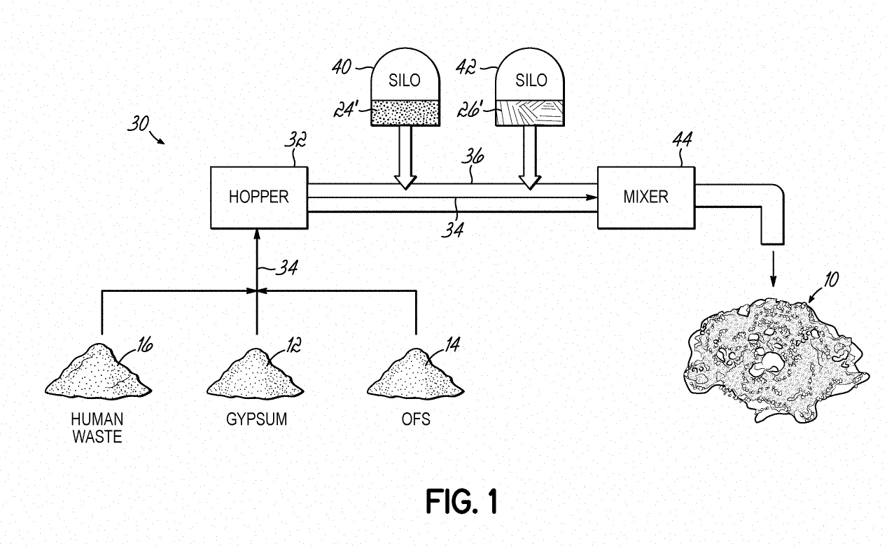

With reference to FIG. 1, according to embodiments of the present invention, an artificial soil 10 may be manufactured by combining one or both of a synthetic gypsum 12 or a gypsum depleted by-product (OFS) 14 in specific proportions with human originated biosolids 16 and a calcium-containing material, for example one or both of a lime kiln dust (LKD) 20 and a hydrated lime 22. As is indicated in FIG. 1, a fluidized bed ash 24 may be used as an alternative to the hydrated lime 22 or an alternative to LKD 20. Another calcium-containing material that is mixable with the biosolids 16 according to embodiments of the present invention may include a ball mill lime 26. All of these materials are described in detail below.

The artificial soil 10 may be applied to land which lacks topsoil or to soil that is degraded. Embodiments of the invention may therefore permit a layer of topsoil to be manufactured, which can facilitate immediate plant growth at locations which would not otherwise support vegetation for many years. These locations may include newly constructed earthworks, such as roads, strip mines, and landfills among others. Embodiments of the present invention are not limited to these exemplary applications. As an example, the artificial soil 10 may be directly applied to crop land to enhance natural topsoil already present. As another example, the artificial soil 10 may be mixed with natural topsoil prior to distributing the mixture on land. The artificial soil 10 may act as an extender in these situations. As yet another example, the artificial soil 10 may be mixed with clay, which generally does not support plant growth, prior to distributing that mixture on land.

In the exemplary embodiment shown in FIG. 1, a system 30 for manufacturing the artificial soil 10 includes a load hopper 32 into which a mixture 34 of the human originated biosolids 16 and one or both of the gypsum 12 and OFS 14 may be loaded. As shown, the gypsum 12, the OFS 14, and the biosolids 16 may each be present in bulk, i.e., a pile. The mixture 34 may be formed by scooping selected bulk portions of the biosolids 16 and one or both of the gypsum 12 and OFS 14 from their respective piles. This may be achieved with a front-end loader, for example, or other similar bulk materials handling equipment. The gypsum 12, the OFS 14, and the biosolids 16 may be mixed in any order by scooping proportions of each pile into a bucket of the front-end loader prior to dumping the contents of that bucket into the hopper 32.

The load hopper 32 directs the mixture 34 onto a conveyor belt 36 or other materials transfer device. As shown, the conveyor belt 36 carries the mixture 34 proximate silos 40 and 42. The silo 40 may house the LKD 20 or the fluidized bed ash 24 in a position to discharge it in continuous fashion on the mixture 34 as it passes beneath the silo 40. The silo 42 may house the hydrated lime 22 or the ball mill lime 26 in a position to discharge it onto the mixture 34 as it passes beneath the silo 42. The discharge from any single one of the silos 40, 42 may be by way of an auger, vane feeder, or belt conveyor though the system is not limited to these named devices. Although two silos 40 and 42 are shown, a single silo may be sufficient to deposit any one or a combination of the LKD 20, the hydrated lime 22, the fluidized bed ash 24, and the ball mill lime 26 onto the mixture 34. The volumetric ratio of the mixture 34 to any one of the LKD 20, the hydrated lime 22, the fluidized bed ash 24, and the ball mill lime 26 may be adjusted by changing the speed of the conveyor belt 36 past the silos 40, 42 and/or the feed rate of the individual materials from the silos 40, 42 to the conveyor belt 36.

Once deposited onto the mixture 34, one or more of the LKD 20, the hydrated lime 22, the fluidized bed ash 24, and the ball mill lime 26, and the mixture 34 are carried into a mixer 44. By way of example only, the mixer 44 may be a pug mill or a paddle mixer. The mixer 44 thoroughly mixes each of the mixture 34 and one or more of a combination of the LKD 20, the hydrated lime 22, the fluidized bed ash 24, and the ball mill lime 26.

During or immediately subsequent to mixing, the temperature increases to about 143° F. or higher, for example to at least about 230° F. In one embodiment, the ratio of the lime-containing materials (i.e., the LKD 20, the hydrated lime 22, the fluidized bed ash 24, and the ball mill lime 26) in the artificial soil 10 is sufficient to heat the artificial soil 10 to above about 132° F. for at least about 72 hours. The temperature may increase to about 230° F. or to about 270° F. within about 35-40 minutes of mixing. By way of example, the ratio of lime-containing material to biosolids 16 may be from about 4 wt. % to about 25 wt. % lime-containing material per ton of biosolids 16. By way of specific example, the LKD 20 may be in the range of about 4 wt. % to about 18 wt. % per ton of biosolids 16. The ratio may depend on the efficacy of the lime-containing materials. There may be some variation in the potency of each of these lime-containing materials. As the potency decreases, the amount of the lime-containing material added must be increased and as the potency increases, the amount of lime-containing material can be reduced. In one particular example, 10 wt. % of the LKD 20 to biosolids 16 may be sufficient to heat the artificial soil 10 following exit from the mixer 44 to a temperature of about 132° for about 72 hours. In that regard, the artificial soil 10 may be classified as a Class A material.

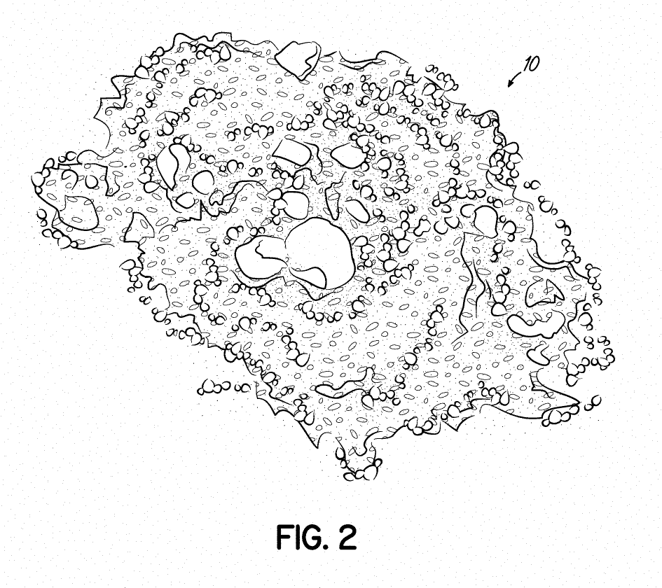

With reference to FIGS. 1 and 2, during mixing, moisture in the mixture 34 reacts with the lime-containing material or is driven off by heat from that reaction so that the artificial soil 10 may appear as a dry granular mixture at some point after exiting the mixer 44. As shown in FIG. 1, the artificial soil 10 may be piled at or near the mixer 44. The discharge from the mixer 44 may be directed into a bulk super sack or a bulk tote for immediate shipment or storage. The temperature of the artificial soil 10 may increase and may remain at an elevated temperature for a few hours or so. Following reaction heating, the artificial soil 10 may then be transported and applied to land for use. It may be required by regulation that the artificial soil 10 be stored for a set time period and assessed for bacterial activity prior to being used.

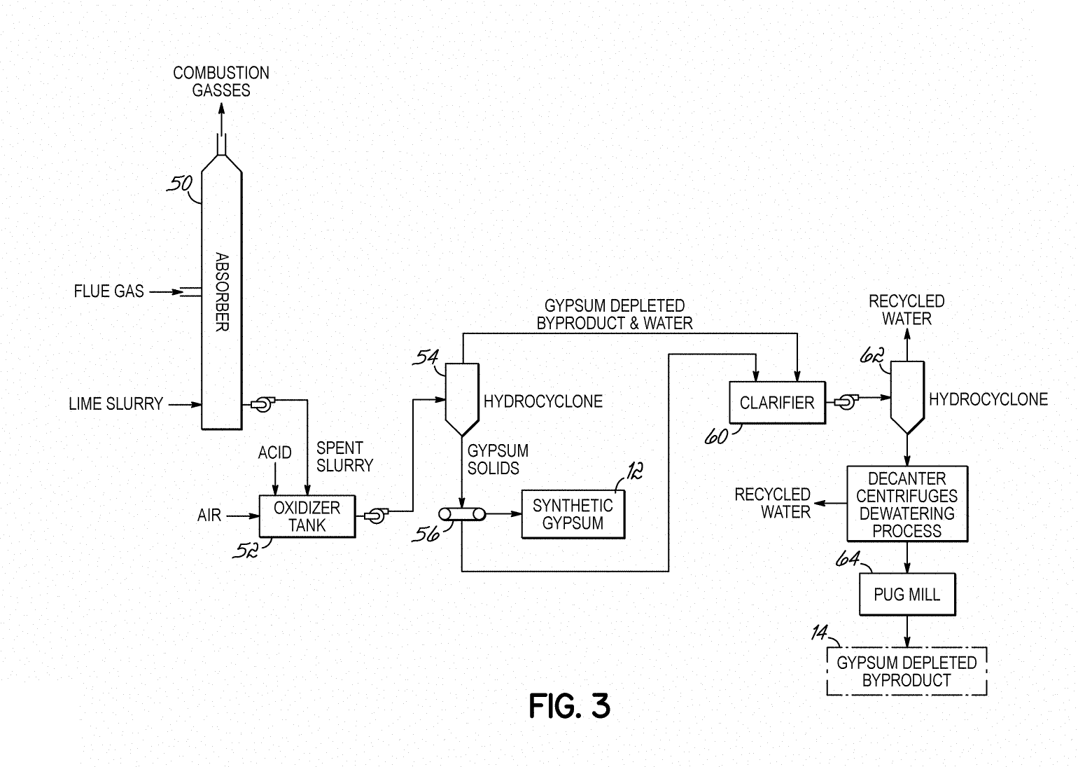

With reference to FIG. 3, the synthetic gypsum 12 and the OFS 14 are produced by a coal burning power plant (not shown). During normal operation of the coal burning power plant, flue gas from the burning coal flows through an absorber 50. Scrubbers remove sulfur dioxide from the flue gas by injecting a slurry of water and lime or limestone material into the absorber 50. The calcium in the lime slurry reacts with the sulfur dioxide in the flue gas and forms a compound containing calcium and sulfur. Once the slurry passes through the absorber 50, the slurry is cycled through a water treatment process.

The water treatment process has many purposes. One purpose is to oxidize any calcium sulfite to calcium sulfate. In FIG. 3, the spent slurry is collected in oxidizer tank 52. Compressed air and acid (e.g., sulfuric acid) are added to the slurry in the tank 52 at temperatures of between about 130° F. and about 150° F. At these temperatures, any calcium sulfite present is oxidized. The resulting calcium sulfate (referred to as synthetic gypsum) is removed from the water by filtering, such as with hydrocyclones 54 and dewatering belts 56. In bulk, the gypsum 12 may contain significant residual moisture after being filtered from the water. By way of example only, by weight, the gypsum 12 may include from about 17 wt. % to about 23 wt. % moisture. Often the synthetic gypsum 12 is separated from any residual waste materials and is sold for use in drywall manufacturing. Any residual waste that is depleted of gypsum may be further treated.

Additional treatment of the stream after removing the synthetic gypsum 12 may include a secondary water treatment process in a clarifier 60. Addition of various flocculation polymers in the clarifier 60 facilitates flocculation of fine, unsettled particles. The flocculated particles settle under gravity. Other additives may be added to the clarifier 60 or at other locations, for example other additives may include biocides to control the bacteria content.

Once the flocculated particles settle in the clarifier 60, they are pumped through an additional dewatering step, such as through a hydrocyclone 62. The discharge from the hydrocyclone 62 may be introduced into a decanter centrifuge 66 which may further dewater the waste stream followed by a pug mill 64. In addition to recycled water being discharged from the decanter centrifuge 66, the OFS 14 (i.e., gypsum depleted by-product) is also discharged. OFS 14 may appear as an orange, paste-like sludge. Synthetic gypsum 12, by contrast, is a pure white material. The OFS 14 is a waste product, or by-product, of the FGD process following removal of commercially pure gypsum. Similar to the gypsum 12, in one embodiment, the OFS 14 may include a significant proportion of water. By way of example only, the OFS 14 may include from about 35 wt. % to about 50 wt. % moisture, though the OFS may average about 43 wt. % moisture. Typically, the OFS 14 is dumped in a landfill. Details regarding products and methods of making products that include OFS are found in commonly-owned U.S. Pat. Nos. 8,303,842; 8,389,439; 8,669,203; and 9,045,367, which are incorporated by reference herein in their entireties. It will be appreciated that while the gypsum 12 and the OFS 14 are described as being produced from related processes, embodiments of the present invention are not limited to a single process that produces synthetic gypsum 12 and the OFS 14. For example, synthetic gypsum 12 may be produced from a process in which no OFS is manufactured.

With reference to FIG. 1, in one embodiment, the biosolids 16 are obtained from a public wastewater treatment plant. By way of example only, and not limitation, the wastewater treatment plant of Clermont County, Ohio, treats residential and industrial solid waste, i.e., sewage. In general, the treatment process includes physical, chemical, and biological processes to remove contaminants from and purify the water for release into the environment. Although not shown, separation may initially include screening the sewage of large non-fecal objects, such as diapers, bottles, rags, etc., and may also include filtering the sewage of inorganic material, such as rocks and sand. Following screening/filtering, treatment may include settling of the solid fecal material.

In that regard, the filtered sewage is pumped into a tank where the solids settle under gravity. This stage may include multiple settling processes. The settled sludge is continuously scraped from the bottom of the tank and pumped away for further treatment. In a second stage, the water and any unsettled sludge is pumped to an aeration tank in which air is pumped through the water. Oxygen in the air encourages the bacteria present to break down any residual solids in the tank after sludge removal. The aerated water may be pumped to another settling tank where any residual solids form sludge at the bottom of the settling tank. A final filtering process through a bed of sand and/or carbon may remove any remaining solid particles from the water before the water is released to the environment.

Wastewater treatment may also include biological nutrient removal processes in which microorganisms remove organic matter, nitrogen, and phosphorous. This process may also include exposing the microorganisms to ultraviolet light to inactivate pathogenic microorganisms.

The sludge from the settling processes may be pumped into a digester in which anaerobic digestion reduces the volume of the sludge while producing methane and carbon dioxide gases. Following digestion, the remaining sludge may be used in the formation of the artificial soil 10 as the biosolids 16 shown in FIG. 1. The biosolids 16 may contain a significant proportion of water, for example at least about 10 wt. % water.

With reference to FIG. 1, in one embodiment, the LKD 20 is a by-product of a lime manufacturing process (not shown). LKD is a very fine powder produced during a calcination process of limestone. This may be for the production of Portland cement clinker and for the production of lime injection material in the FGD scrubber process. In either process, crushed limestone may be fed into a rotary kiln. Thermal decomposition of the limestone in the kiln during calcination produces quicklime and the LKD 20. In that regard, the LKD 20 may contain roughly equal amounts of quicklime (CaO) and calcium carbonate (CaCO₃) or lesser amounts of calcium carbonate than quicklime. In addition to the calcium-containing constituents, LKD may contain numerous impurities, such as magnesia (MgO), silica (SiO₂), alumina (Al₂O₃), and other impurities common to the limestone placed in the rotary kiln. These oxide impurities may amount to about 20 wt. % to about 33 wt. % of the total weight of the LKD 20. Because the LKD 20 is composed of fine particles, it is typically captured by a dust control system that filters the exhaust from the rotary kiln. The LKD particles are typically in the range of 0.03 mm or smaller. LKD is commercially available from Omni Materials, Inc. of Maysville, Ky.

With reference to FIG. 1, in one embodiment, the hydrated lime 22 may be referred to as calcium hydroxide (Ca(OH)₂). The hydrated lime 22 in the form of powder may be prepared by adding quicklime (CaO) to water (referred to as slaking). The hydrated lime 22 is commercially available from Carmeuse, Maysville, Ky.

With reference to FIG. 1, in one embodiment, the fluidized bed ash 24 is a solid waste product of fluidized bed combustion, for example from coal combustion for electrical power generation. As is known in fluidized bed combustion of coal, particles of coal are suspended in a fluidized bed that contains other particles including particles of a lime-containing material. Typically, the lime is supplied by limestone that is crushed, calcined, and then injected into the fluidized bed. The lime reacts with sulfur dioxide gas from sulfur impurities in the coal to form solid calcium-sulfur compounds that are captured in the ash from the combustion process. Thus, fluidized bed combustion significantly reduces SOₓ emissions without the need for a system described above and shown in FIG. 3. The fluidized bed ash 24 is a residual solid by-product from the calcium-sulfur reaction and contains calcium-sulfur compounds and other calcium-containing compounds, including unreacted quicklime (CaO) and impurities from the source of calcium utilized in the reaction with sulfur in the coal. Because limestone includes other oxides, the fluidized bed ash will also include similar impurities, as well as other impurities from the coal. The impurities may be in oxide form and include silica (SiO₂), alumina (Al₂O₃), hematite (Fe₂O₃), magnesia (MgO), potassium oxide (K₂O), sodium oxide (Na₂O), and others. The fluidized bed ash 24 is commercially available from Omni Materials, Maysville, Ky.

With reference to FIG. 1, the ball mill lime 26 is a waste product of an FGD process, described above. In general, ball mill lime is residual waste from recycling the unused lime-injection materials in the flue gas desulfurization process described above. The ball mill lime 26 is available from electrical power generation plants, such as the Zimmer Power Station in Moscow, Ohio.

The artificial soil 10, shown in FIGS. 1 and 2, may be distributed in a location where there is a lack of topsoil, such as over un-remediated strip mines and along roadways to support the growth of vegetation, such as crops. Additional additives, such as fertilizers, may be added to the content of the artificial soil 10.

In order to facilitate a more complete understanding of the invention, the following non-limiting examples are provided. The biosolids in each of the examples below were provided by the Clermont County Wastewater District in Ohio. Also, in each of the examples that follow, it is believed that the temperature of the mixture reached at least approximately 172° F. and remained at that temperature for from 2 to 4 hours after mixing in a cement mixer.

### Example 1

One 5 gallon bucket of biosolids was mixed with one 5 gallon bucket of ball mill lime. The mixing ratio was about 1 to 1 by volume. The ball mill lime was provided by Zimmer Power Station. The two buckets were dumped into a cement mixer and then mixed.

Table 1 lists analytical results for a sample of the ball mill lime used in the Examples.

TABLE 1

| COMPOSITION | Result (wt. %) | | Method |
|---|---|---|---|
| Moisture | 27.80 | | AOAC 965.08 |
| Calcium | 30.71 | | AOAC 965.09 ICP |
| Magnesium | 2.26% | | AOAC 965.09 ICP |
| CaCO₃Equivalent | 84.86% | | |
| Effective CaCO₃ Equivalent | 55.01% | | |
| No. 8 Screen | — % | retained | |
| No. 20 Screen | 21.7% | retained | |
| No. 60 Screen | 44.6% | retained | |
| No. 100 Screen | 14.5% | retained | |
| No. 100 Screen | 19.3% | passed | |

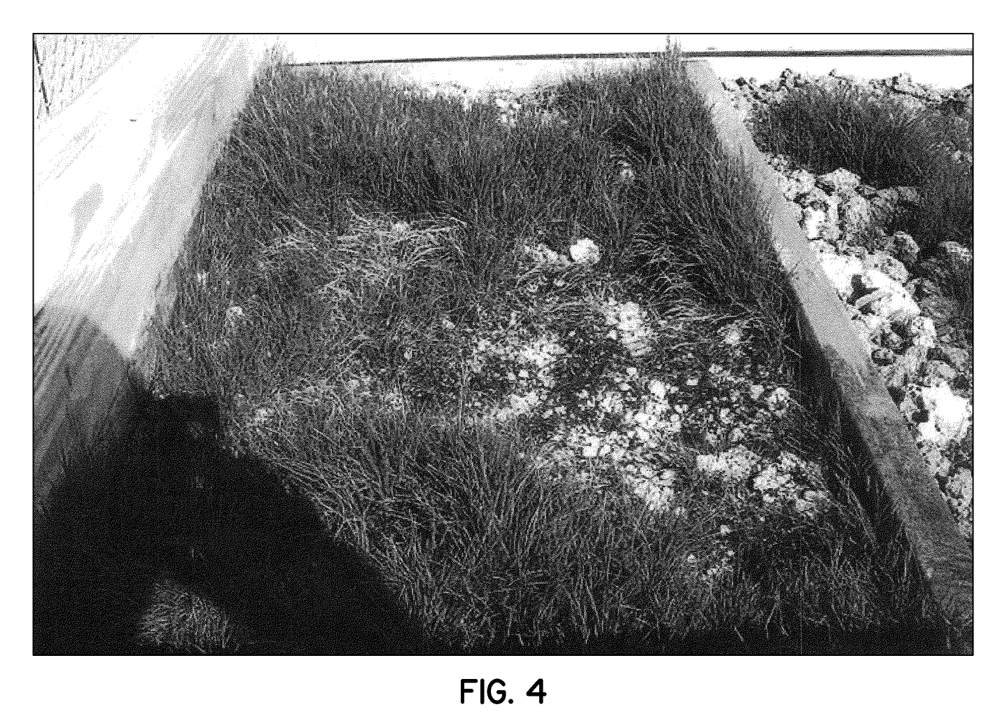

The resulting mixture was poured into a 13 inch by 24 inch wooden tray to a depth of about 6 inches. Grass seed was distributed across the top of the artificial soil. The grass seed was a “Kentucky 31” mixture of blue grass, fescue, clover, and other seed. In normal environmental conditions, the grass seed germinated in about 2 days. A picture of the grass after approximately 3 weeks in the soil of Example 1 is shown in FIG. 4.

### Example 2

One 5 gallon bucket of biosolids was mixed with ¼ of a 5 gallon bucket of LKD. The mixing ratio was one to about one quarter by volume. The buckets were dumped into a cement mixer and then mixed.

Table 2 lists the equivalent oxide composition of the LKD used in the Examples.

TABLE 2

| PRIMARY COMPOSITION | (Average wt. %) |
|---|---|
| Total CaO | 53.5 |
| Available CaO | 22.7 |
| MgO | 5.9 |
| SiO₂ | 11.75 |
| Al₂O₃ | 5.4 |
| Fe₂O₃ | 1.08 |
| Loss on Ignition LOI | 15.97 |

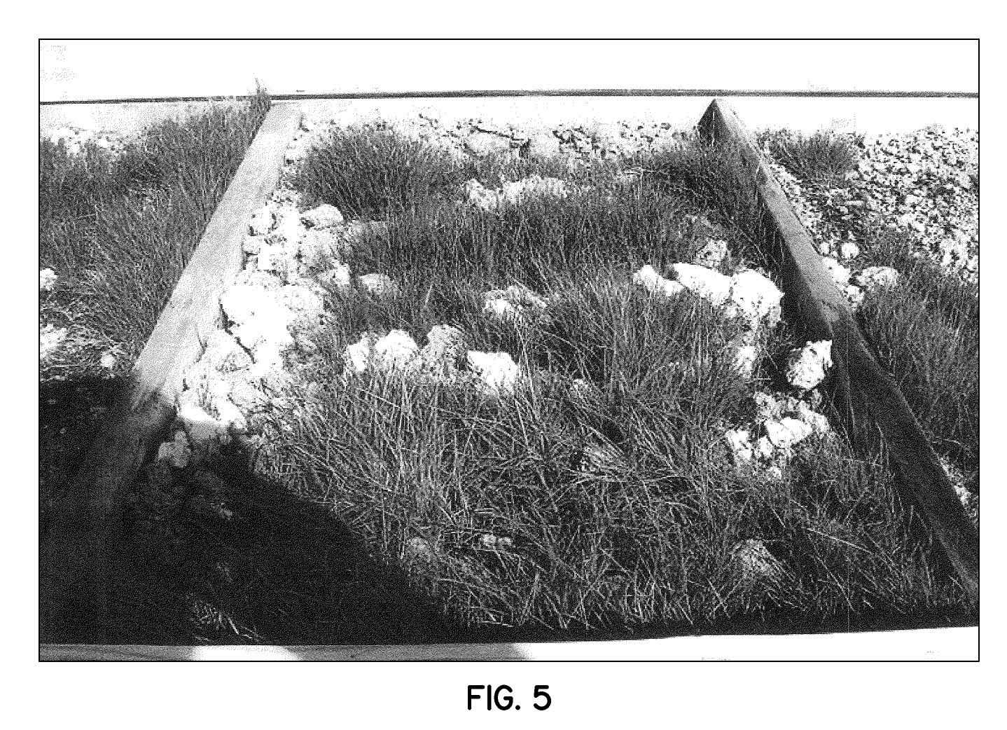

The resulting mixture was poured into a 13 inch by 24 inch wooden tray to a depth of about 6 inches. Grass seed was distributed across the top of the artificial soil. The grass seed was a “Kentucky 31” mixture of blue grass, fescue, clover, and other seed. In normal environmental conditions, the grass seed germinated in about 2 days. A picture of the grass after approximately 3 weeks in the soil of Example 2 is shown in FIG. 5.

The table below provides another exemplary composition of the LKD usable in artificial soils. By way of further example, the constituents usable in artificial soil may range from the composition of Table 2 to the composition provided in Table 3.

TABLE 3

| PRIMARY COMPOSITION | (Average wt %) |
|---|---|
| Total CaO | 49.0 |
| Available CaO | 28.0 |
| MgO | 3.31 |
| SiO₂ | 8.30 |
| Al₂O₃ | 6.38 |
| Fe₂O₃ | 0.98 |
| Loss on Ignition LOI | 20.04 |

### Example 3

One 5 gallon bucket of biosolids was mixed with ¼ of a 5 gallon bucket of LKD of Example 2 and one 5 gallon bucket of ball mill lime of Example 1. The buckets were dumped into a cement mixer and then mixed.

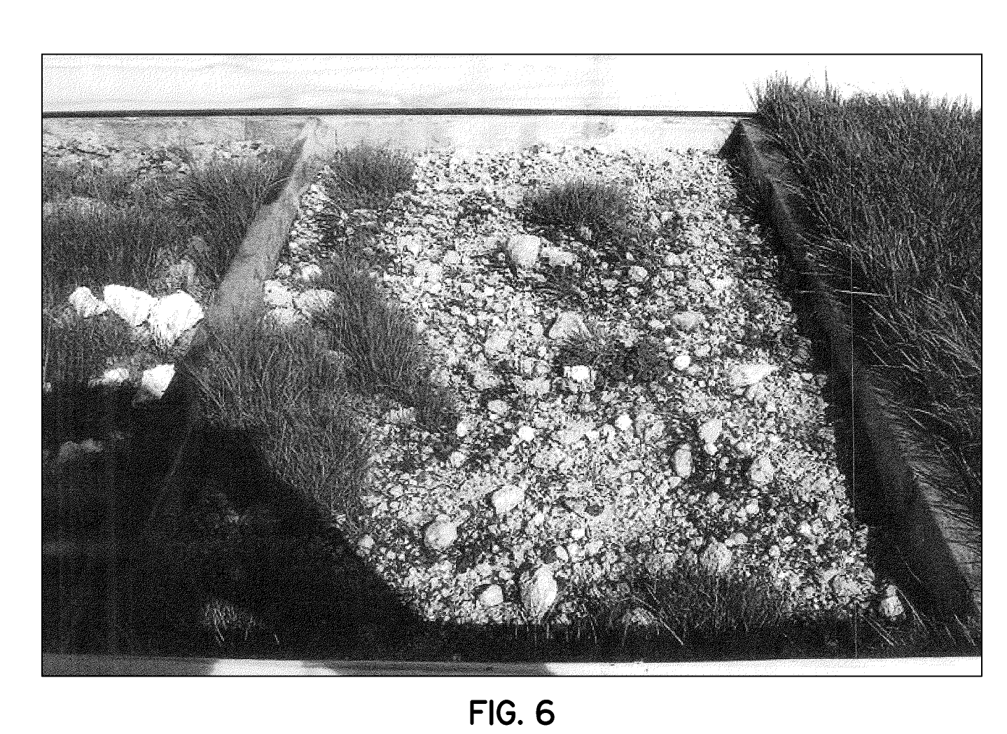

The resulting mixture was poured into a 13 inch by 24 inch wooden tray to a depth of about 6 inches. Grass seed was distributed across the top of the artificial soil. The grass seed was a “Kentucky 31” mixture of blue grass, fescue, clover, and other seed. In normal environmental conditions, the grass seed germinated in about 2 days. A picture of the grass growing in the soil of Example 3 is shown in FIG. 6.

### Example 4

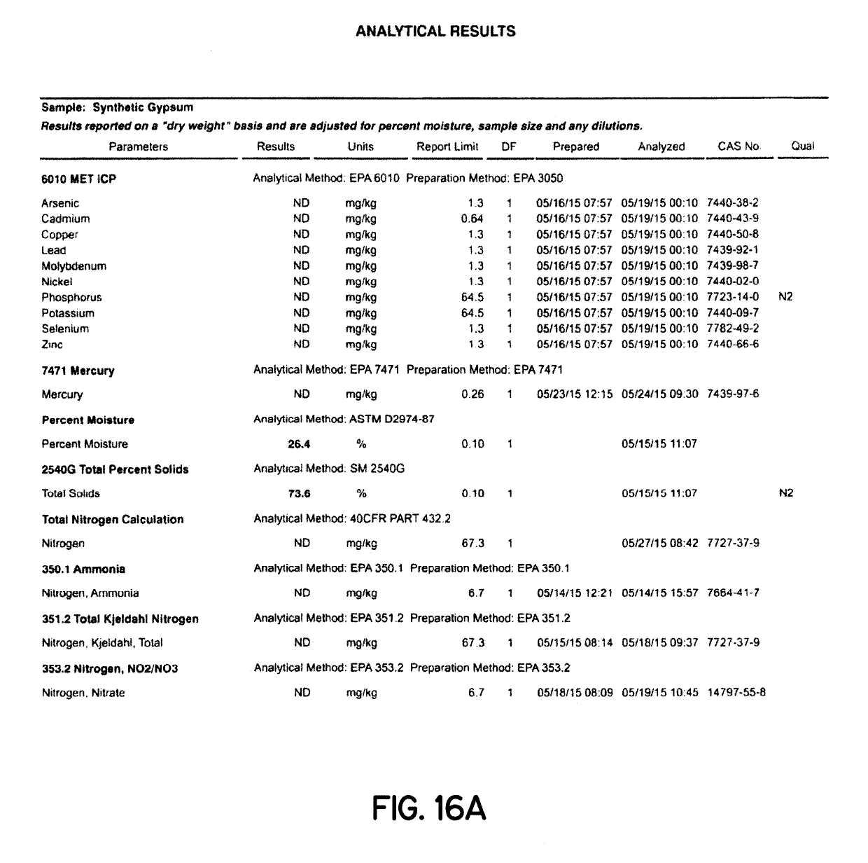

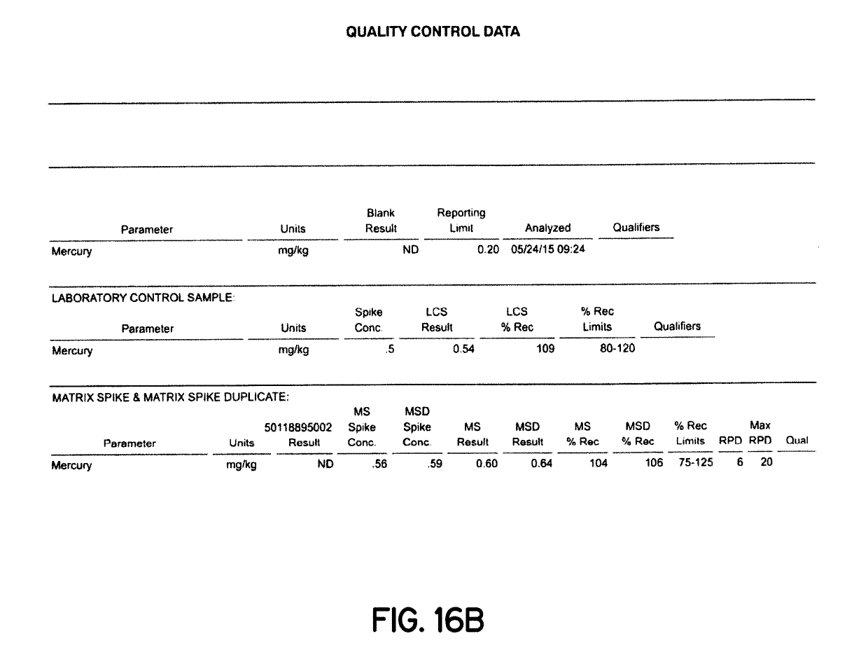

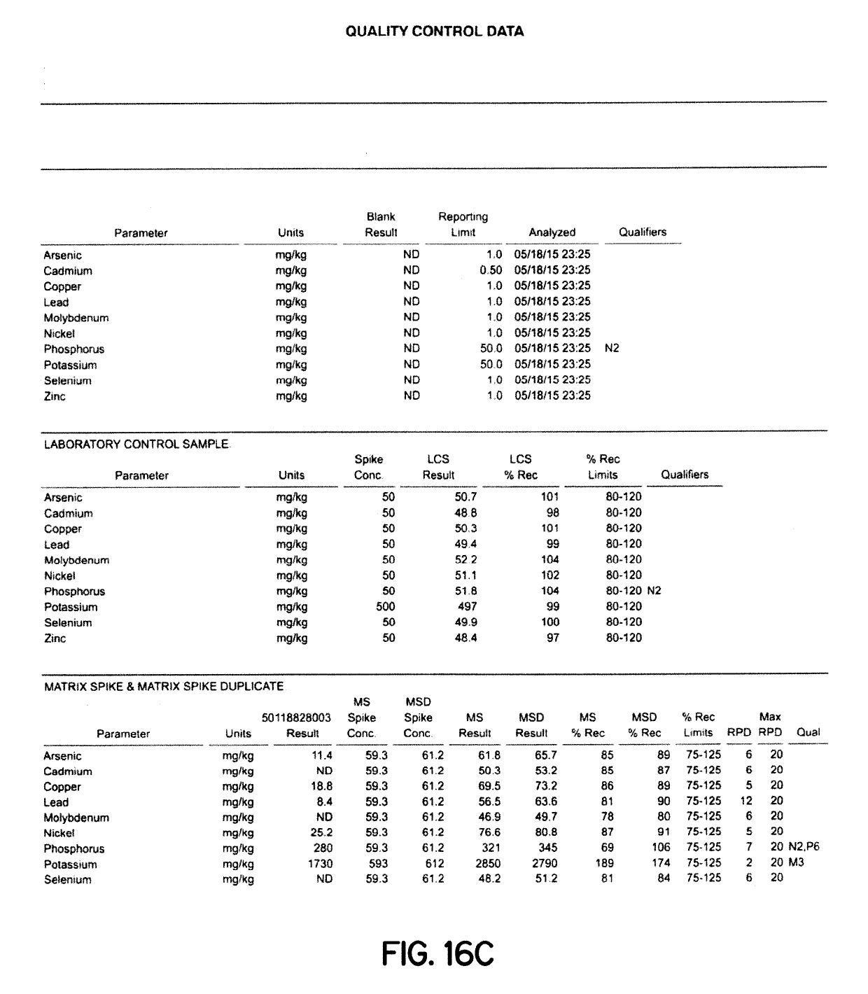

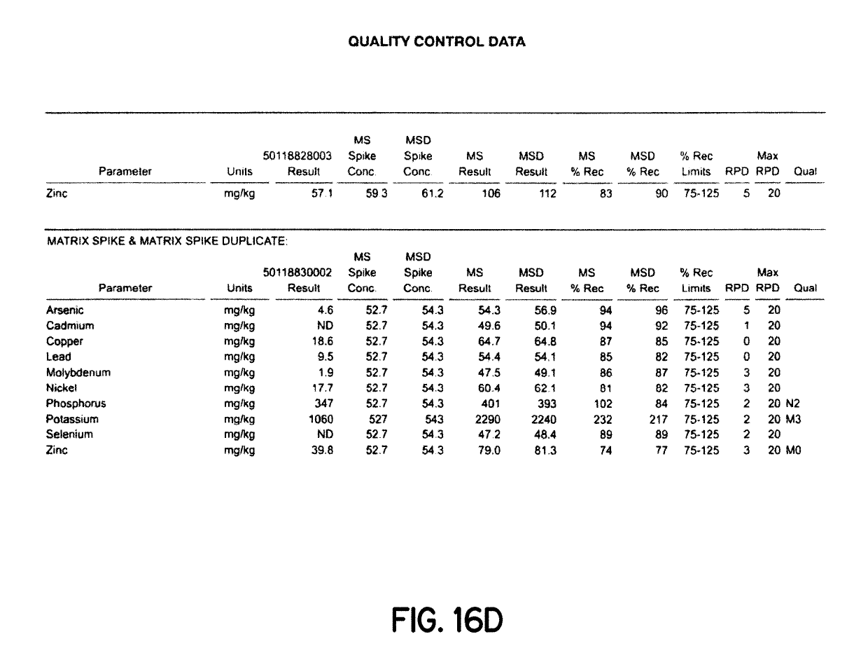

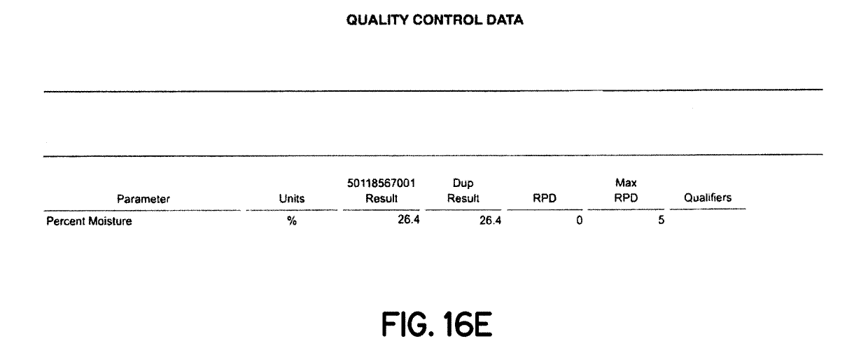

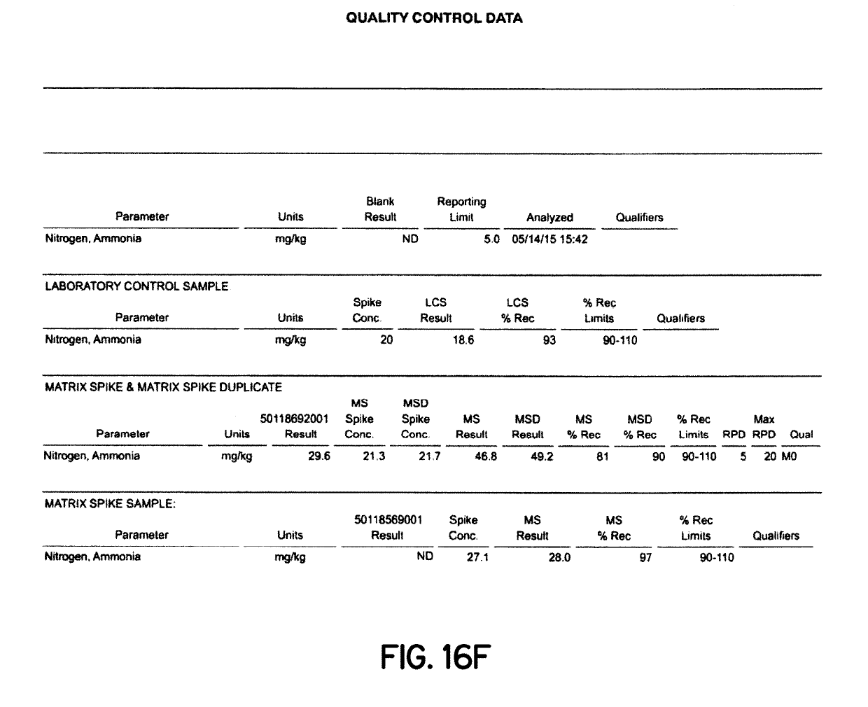

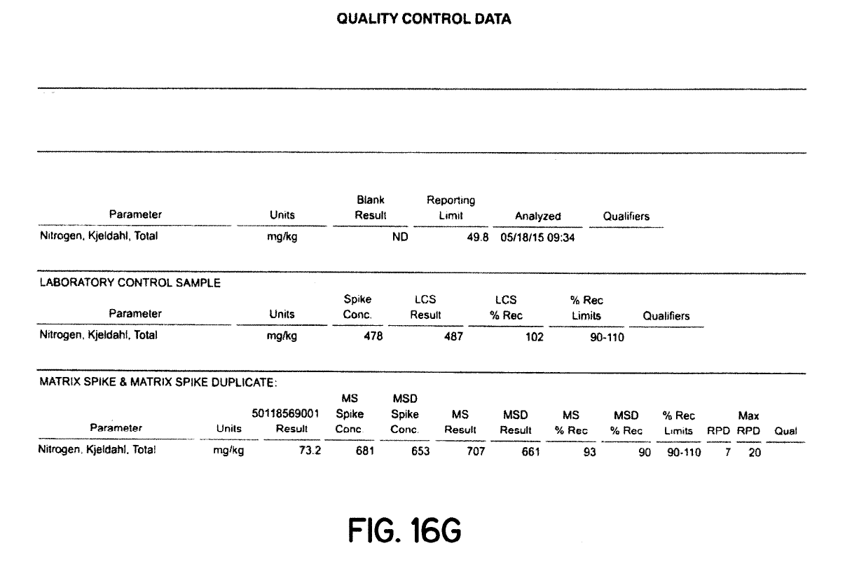

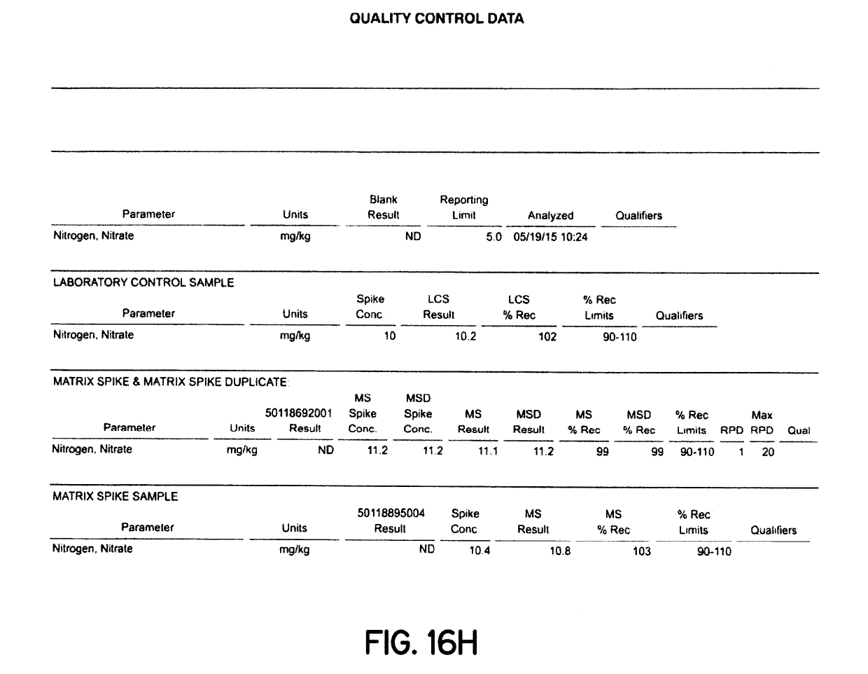

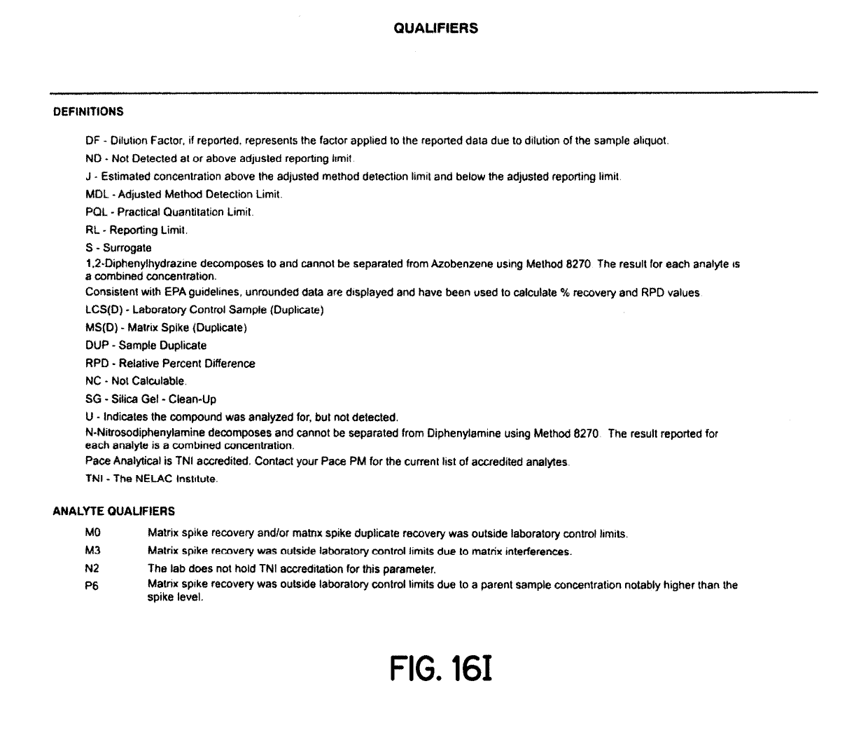

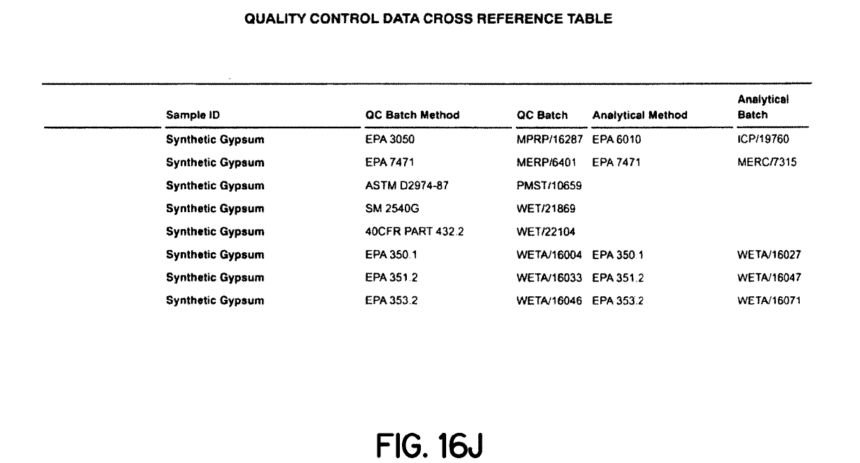

One 5 gallon bucket of synthetic gypsum from the Zimmer Power Station at Moscow, Ohio, was mixed with one 5 gallon bucket of ball mill lime of Example 1 and one 5 gallon bucket of biosolids. The buckets were dumped into a cement mixer and then mixed. See FIGS. 16A-16J for exemplary analytical results of synthetic gypsum from the Zimmer Power Station. Table 4 lists an exemplary compositional analysis of an FGD gypsum usable in artificial soils.

TABLE 4

| PRIMARY COMPOSITION | (wt. %) |
|---|---|
| Sulfate, SO₃ | 53 |
| Calcium, CaO | 39 |
| Loss on Ignition LOI | 7 |
| Silicon, SiO₂ | 1 |

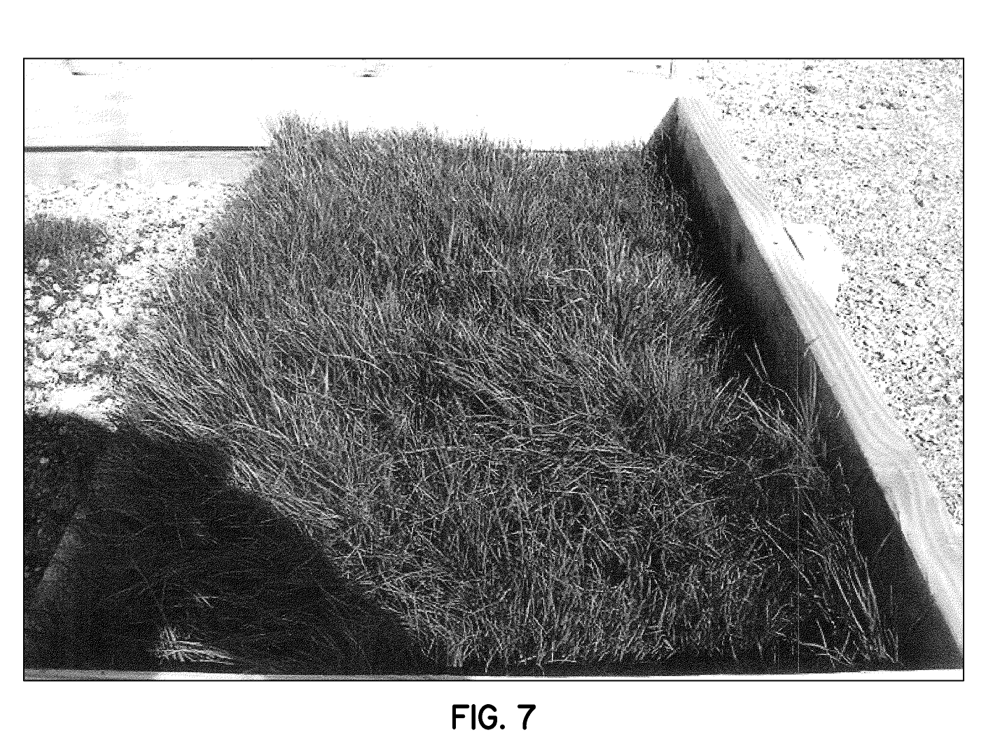

The resulting mixture was poured into a 13 inch by 24 inch wooden tray to a depth of about 6 inches. Grass seed was distributed across the top of the artificial soil. The grass seed was a “Kentucky 31” mixture of blue grass, fescue, clover, and other seed. In normal environmental conditions, the grass seed germinated in about 2 days. A picture of the grass after approximately 3 weeks in the soil of Example 4 is shown in FIG. 7.

### Example 5

One 5 gallon bucket of ball mill lime of Example 1 was mixed with one 5 gallon bucket of synthetic gypsum of Example 4 and ¼ of a 5 gallon bucket of biosolids. The buckets were dumped into a cement mixer and then mixed.

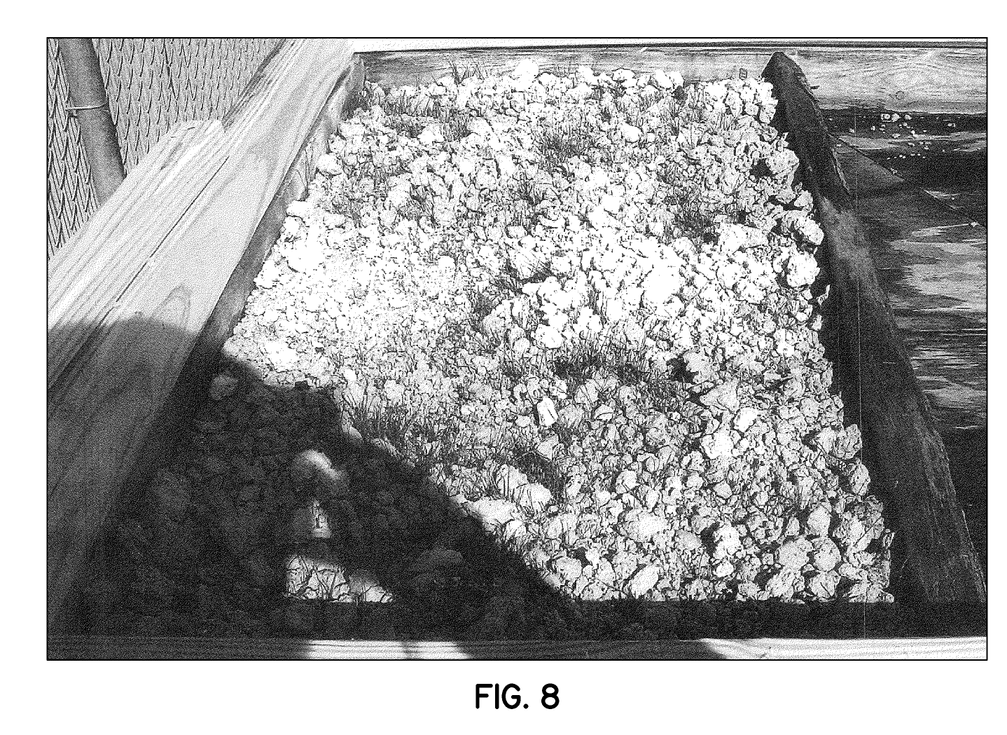

The resulting mixture was poured into a 13 inch by 24 inch wooden tray to a depth of about 6 inches. Grass seed was distributed across the top of the artificial soil. The grass seed was a “Kentucky 31” mixture of blue grass, fescue, clover, and other seed. In normal environmental conditions, the grass seed germinated in about 2 days. A picture of the grass after approximately 3 weeks in the soil of Example 5 is shown in FIG. 8.

### Example 6

One 5 gallon bucket of ball mill lime of Example 1 was mixed with one 5 gallon bucket of biosolids and one 5 gallon bucket of topsoil. The buckets were dumped into a cement mixer and then mixed.

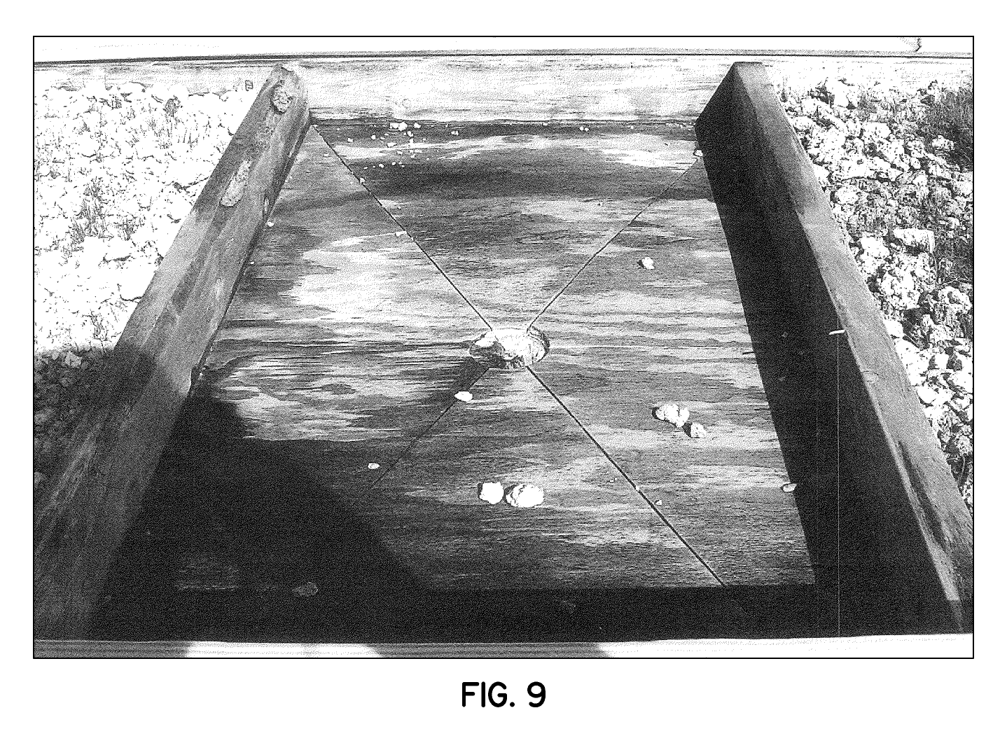

The resulting mixture was poured into a 13 inch by 24 inch wooden tray to a depth of about 6 inches. Grass seed was distributed across the top of the artificial soil. The grass seed was a “Kentucky 31” mixture of blue grass, fescue, clover, and other seed. In normal environmental conditions, the grass seed germinated in about 2 days. FIG. 9 is a picture of this Example 6.

### Example 7

One 5 gallon bucket of OFS from the Zimmer Power Station was mixed with one 5 gallon bucket of biosolids and one 5 gallon bucket of gypsum of Example 4. The buckets were dumped into a cement mixer and then mixed. Table 5 lists an exemplary compositional analysis of OFS usable in artificial soils.

TABLE 5

| PRIMARY COMPOSITION | (wt. %) |
|---|---|
| Loss on Ignition LOI | 12 |
| Sulfate, SO₃ | 39 |
| Calcium, CaO | 25 |
| Silicon, SiO₂ | 8 |
| Magnesium, MgO | 11 |
| Aluminum, Al₂O₃ | 2 |
| Choride, Cl— | 1 |
| Iron, Fe₂O₃ | 1 |
| Fluoride, F— | 1 |

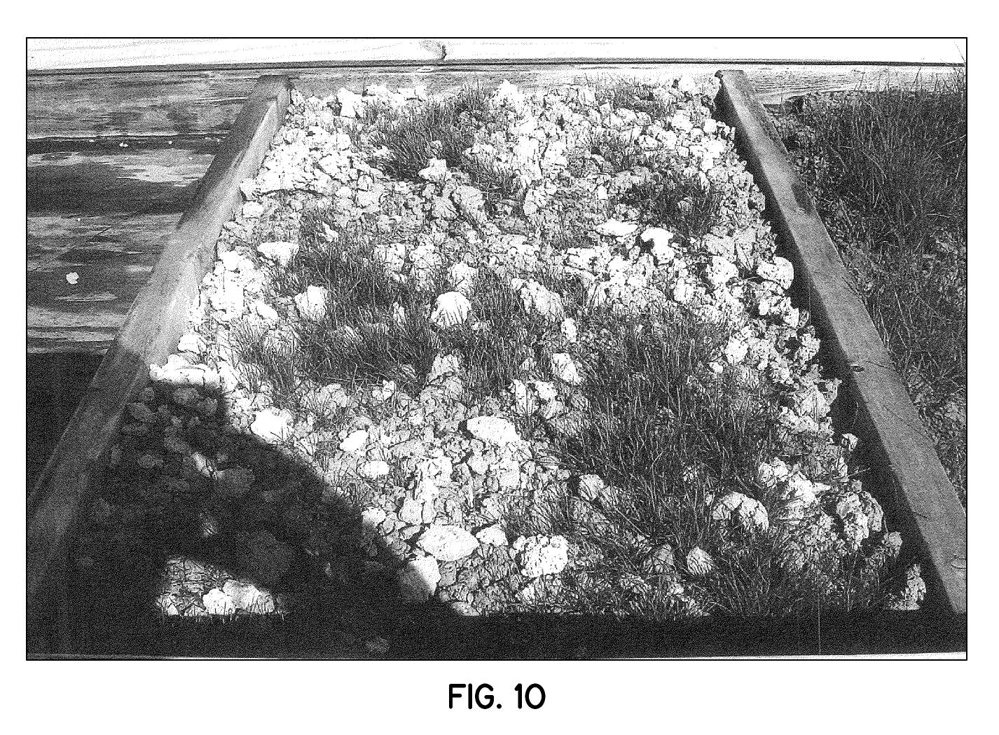

The resulting mixture was poured into a 13 inch by 24 inch wooden tray to a depth of about 6 inches. Grass seed was distributed across the top of the artificial soil. The grass seed was a “Kentucky 31” mixture of blue grass, fescue, clover, and other seed. In normal environmental conditions, the grass seed germinated in about 2 days. A picture of the grass after approximately 3 weeks in the soil of Example 7 is shown in FIG. 10.

### Example 8

One 5 gallon bucket of biosolids was mixed with one 5 gallon bucket of synthetic gypsum of Example 4. The buckets were dumped into a cement mixer and then mixed.

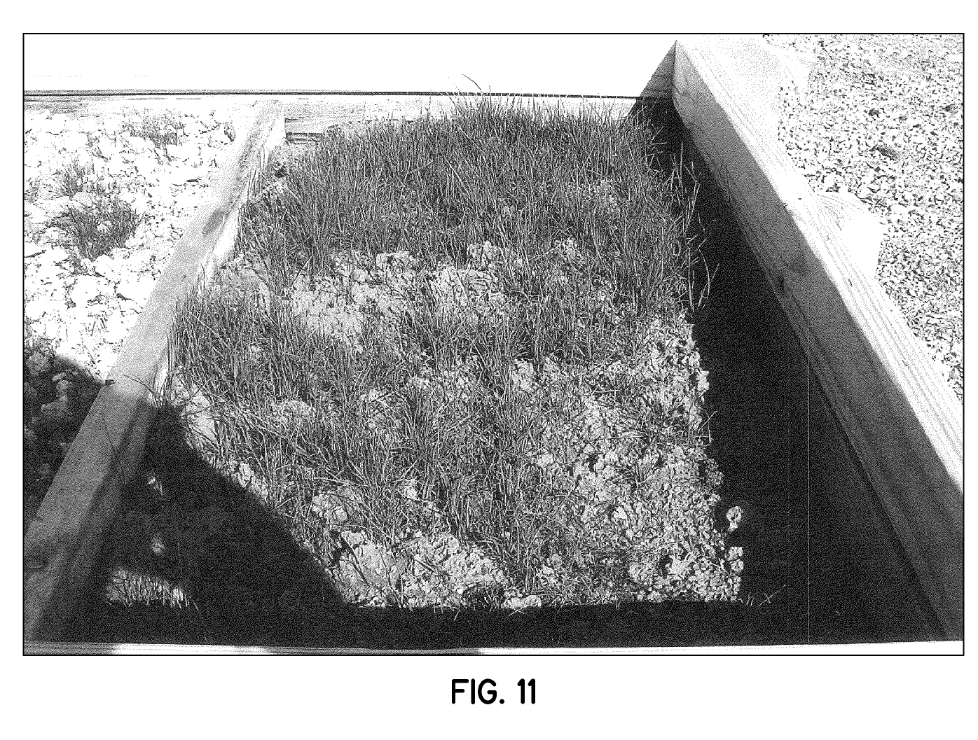

The resulting mixture was poured into a 13 inch by 24 inch wooden tray to a depth of about 6 inches. Grass seed was distributed across the top of the artificial soil. The grass seed was a “Kentucky 31” mixture of blue grass, fescue, clover, and other seed. In normal environmental conditions, the grass seed germinated in about 2 days. A picture of the grass growing in the soil of Example 8 is shown in FIG. 11.

### Example 9

One quarter of a 5 gallon bucket of limestone sand was mixed with ⅛ of a 5 gallon bucket of LKD and one 5 gallon bucket of biosolids. Tables 6A and 6B collectively provide an exemplary analytical composition of limestone sand.

TABLE 6A

| | As Received | | Dry | | Method |
|---|---|---|---|---|---|
| PARAMETER | Basis | | Basis | | Reference |
| Moisture (105° C.) | 30.5 | | 0.0 | | AOAC 950.01 |
| Solids | 69.5 | | 100 | | AOAC 950.01 |
| Calcium (Ca) | 32.1 | wt % | 46.2 | wt % | ASTM C602.20 |
| Calcium (Ca) | 642 | lb/T | 924 | lb/T | ASTM C602.20 |
| Magnesium (Mg) | 1.93 | wt % | 2.78 | wt % | ASTM C602.20/ |
| | | | | | ICP |
| Magnesium (Mg) | 39 | lb/T | 56 | lb/T | ASTM C602.20/ |
| | | | | | ICP |

| Calcium Carbonate | 87.4% | 125.8% | AOAC 955.01 |
|---|---|---|---|
| Equiv. (CCE) | | | |
| Passing U.S. | | 99.4% | AOAC 924.02 |
| #8 Sieve | | | |
| Passing U.S. | | 97.5% | AOAC 924.02 |
| #20 Sieve | | | |
| Passing U.S. | | 92.9% | AOAC 924.02 |
| #60 Sieve | | | |
| Passing U.S. | | 88.8% | AOAC 924.02 |
| #100 Sieve | | | |

TABLE 6B

| | As Received | Dry | Method |
|---|---|---|---|
| PARAMETER | Basis | Basis | Reference |
| Total Neutralizing Power | 87.4% | 125.8% | Ohio Dept |
| | | | Ag 905.51 |
| Fineness Index | | 96.0% | Ohio Dept |
| | | | Ag 905.51 |
| Effective Neutralizing | 1679 lb/T | 2416 lb/T | Ohio Dept |
| Power | | | Ag 905.55 |

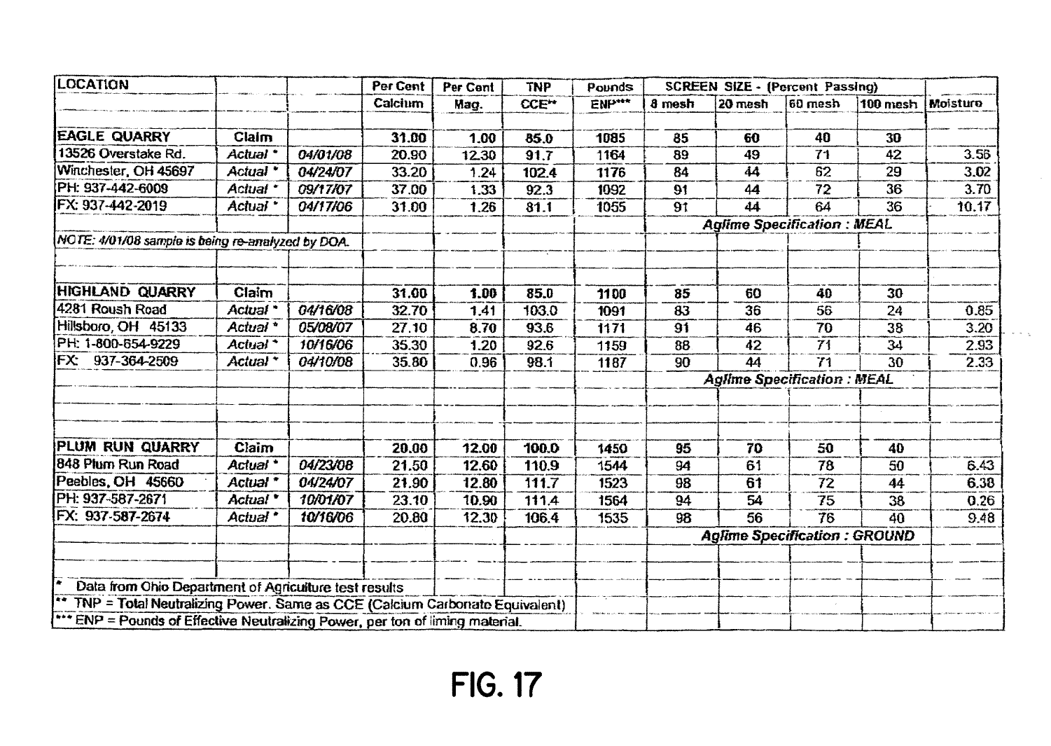

Alternative compositions of limestone sand are found in FIG. 17.

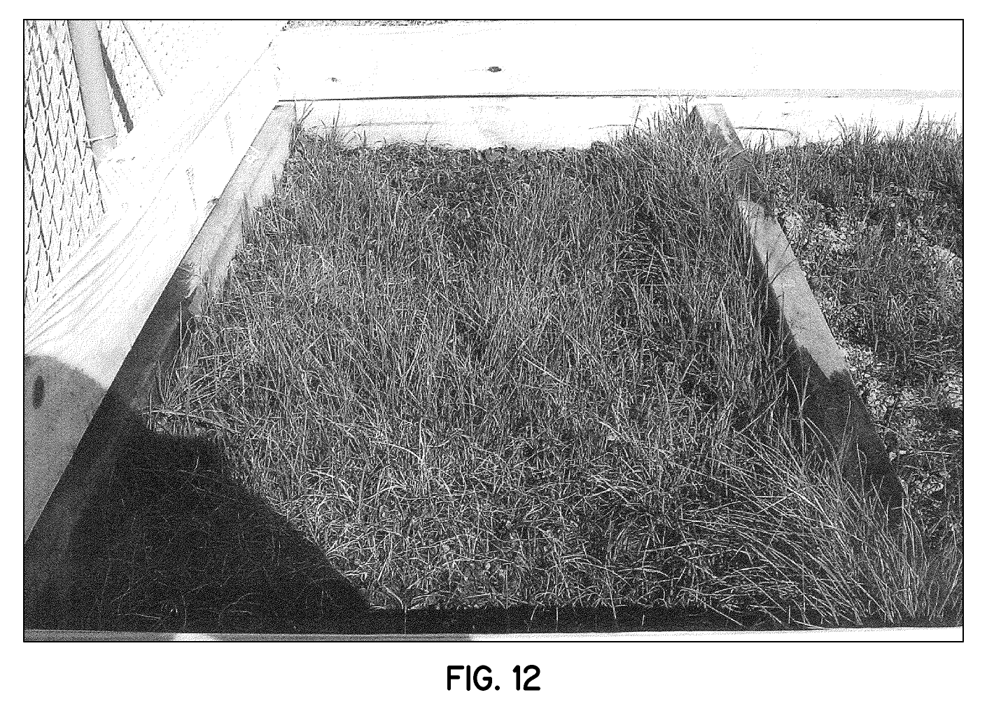

The resulting mixture was poured into a 13 inch by 24 inch wooden tray to a depth of about 6 inches. Grass seed was distributed across the top of the artificial soil. The grass seed was a “Kentucky 31” mixture of blue grass, fescue, clover, and other seed. In normal environmental conditions, the grass seed germinated in about 2 days. A picture of the grass after approximately 3 weeks in the soil of Example 9 is shown in FIG. 12.

### Example 10

One 5 gallon bucket of OFS of Example 7 was mixed with one 5 gallon bucket of biosolids and one 5 gallon bucket of ball mill lime of Example 1. The buckets were dumped into a cement mixer and then mixed.

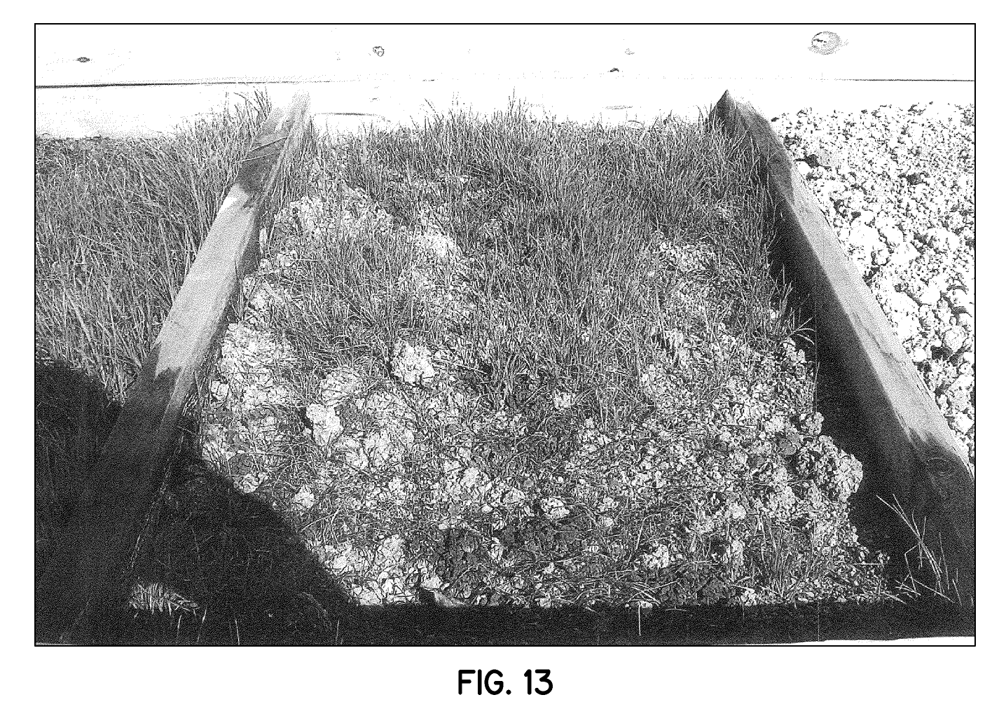

The resulting mixture was poured into a 13 inch by 24 inch wooden tray to a depth of about 6 inches. Grass seed was distributed across the top of the artificial soil. The grass seed was a “Kentucky 31” mixture of blue grass, fescue, clover, and other seed. In normal environmental conditions, the grass seed germinated in about 2 days. A picture of the grass after approximately 3 weeks in the soil of Example 10 is shown in FIG. 13.

### Example 11

One 5 gallon bucket of OFS of Example 7 was mixed with one 5 gallon bucket of biosolids and ½ of a 5 gallon bucket of synthetic gypsum of Example 4 and ½ of a 5 gallon bucket of LKD of Example 2. The buckets were dumped into a cement mixer and then mixed.

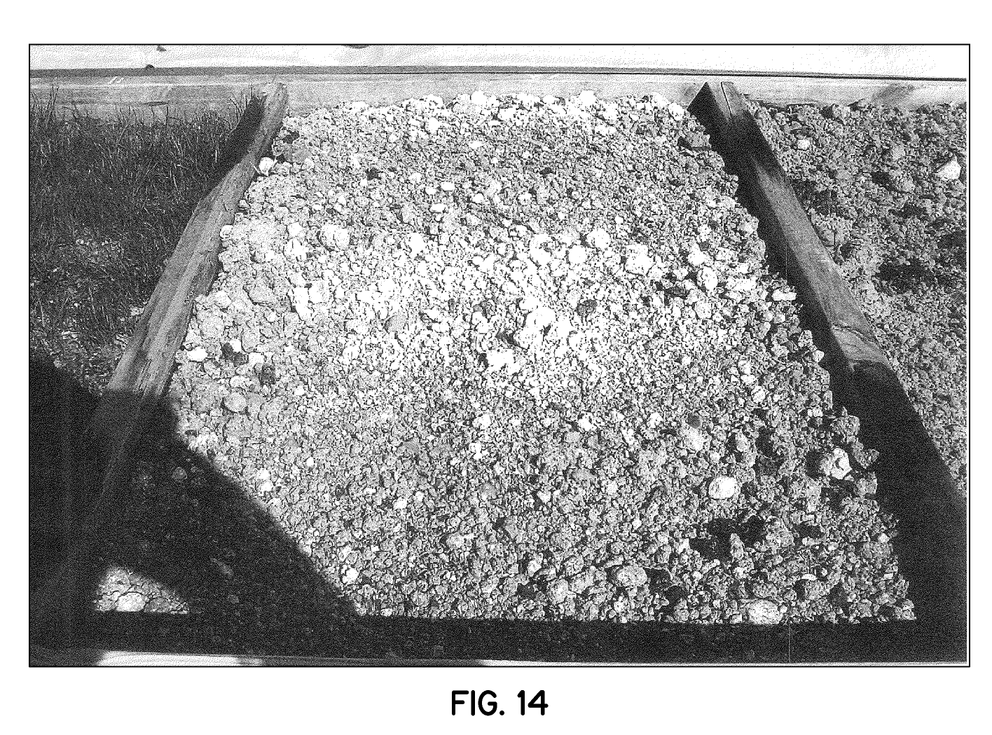

The resulting mixture was poured into a 13 inch by 24 inch wooden tray to a depth of about 6 inches. Grass seed was distributed across the top of the artificial soil. The grass seed was a “Kentucky 31” mixture of blue grass, fescue, clover, and other seed. A picture of the soil after approximately 3 weeks is shown in FIG. 14.

### Example 12

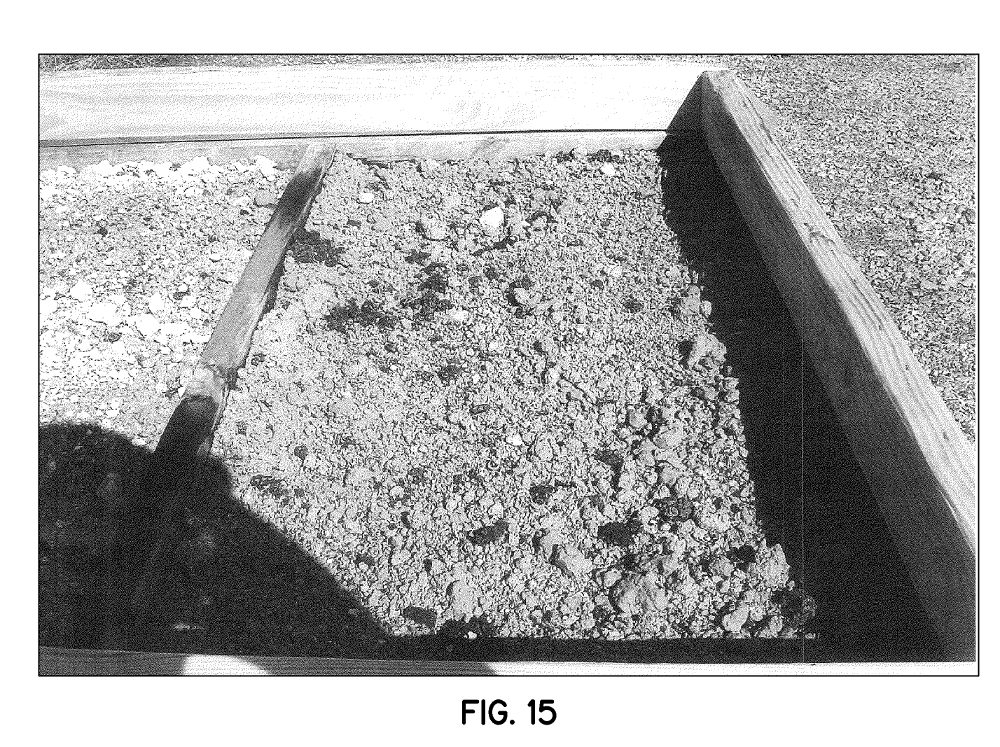

One 5 gallon bucket of OFS of Example 7 was mixed with one 5 gallon bucket of biosolids and ½ of a 5 gallon bucket of synthetic gypsum of Example 4 and one 5 gallon bucket of ball mill lime of Example 1. The resulting mixture was poured into a 13 inch by 24 inch wooden tray to a depth of about 6 inches. Grass seed was distributed across the top of the artificial soil. The grass seed was a “Kentucky 31” mixture of blue grass, fescue, clover, and other seed. A picture after approximately 3 weeks is shown in FIG. 15.

In each of the examples above, each of a 5 gallon bucket of ball mill lime, a 5 gallon bucket of LKD, a 5 gallon bucket of OFS, and a 5 gallon bucket of biosolids weighs about 45 pounds.

Potential applications for artificial soils that support plant growth include topsoil replacement in areas that lack sufficient soil quantity and/or quality of soil, such as around new construction.

The following tables provide a comparison of various characteristics of each of the Examples 1-12, above.

TABLE 7

| | | | | | | Salts |
|---|---|---|---|---|---|---|
| | NO₃—N | NH₄—N | N | Na m3 | Na | mmhos/ |
| Example | (ppm) | (ppm) | Content* | -ppm | Sat % | cm |
| 1 | 39 | 7 | 39 | 33 | 0.6 | 4.28 |
| 2 | 141 | 10 | 141 | 108 | 1.1 | 1.18 |
| 3 | 94 | 2 | 94 | 71 | 1 | 3.78 |
| 4 | 30 | 1 | 30 | 21 | 0.3 | 4.72 |
| 5 | 19 | 3 | 19 | 24 | 0.5 | 6.22 |
| 6 | 13 | 7 | 13 | 21 | 0.5 | 6.08 |
| 7 | 11 | 11 | 11 | 61 | 0.6 | 1.87 |
| 8 | 9 | 5 | 9 | 62 | 1.3 | 1.69 |
| 9 | 25 | 7 | 25 | 90 | 1.1 | 1.69 |
| 10 | NA | NA | NA | NA | NA | NA |
| 11 | 47 | 6 | 47 | 91 | 0.7 | 2.11 |
| 12 | NA | NA | NA | NA | NA | NA |

*Sample N Content calculated as follows: If NH₄—N is less than 16 then Example N Content equals NO₃—N If NH₄—N is greater than or equal to 16 then Example N Content equals NO₃—N + (0.5 * NH₄—N)

TABLE 8

| | | | Analysis Result and Rating | | | |
|---|---|---|---|---|---|---|
| | Soil | Organic | | K | Mg | |
| Example | pH | Matter (%) | P (ppm) | (ppm) | (ppm) | Ca (ppm) |
| 1 | 12.4 | 4.4 | 14 L | 116 M | 1167 V | 72715 V |
| 2 | 9.2 | 6.9 | 71 H | 449 H | 3578 V | 72806 V |
| 3 | 12.3 | 3.6 | 17 M | 261 G | 2256 V | 72733 V |
| 4 | 12.4 | 10.1 | 14 L | 63 L | 1624 V | 100000 V |
| 5 | 12.4 | 5.9 | 3 L | 69 L | 756 V | 100000 V |
| 6 | 12.4 | 2.3 | 3 L | 69 L | 637 H | 100000 V |
| 7 | 9.7 | 8.1 | 171 V | 660 V | 3627 V | 72935 V |
| 8 | 9.1 | 10.7 | 869 V | 165 M | 612 H | 14715 V |
| 9 | 8.6 | 6.5 | 313 V | 213 M | 2824 V | 72850 V |
| 10 | NA | NA | NA | NA | NA | NA |
| 11 | 9 | 7.7 | 56 G | 438 H | 5832 V | 72872 V |
| 12 | NA | NA | NA | NA | NA | NA |

TABLE 9

Base Saturation (%)

| Example | CEC | K | Mg | Ca |
|---|---|---|---|---|
| 1 | 24.0 | 1.0 | 35.7 | 62.6 |
| 2 | 42.7 | 2.3 | 61.5 | 35.1 |
| 3 | 32.4 | 1.7 | 51.0 | 46.3 |
| 4 | 27.1 | 0.5 | 43.9 | 55.3 |
| 5 | 20.8 | 0.7 | 26.7 | 72.1 |
| 6 | 0.7 | 0.7 | 23.5 | 75.3 |
| 7 | 3.3 | 3.3 | 61.4 | 34.7 |
| 8 | 1.8 | 1.8 | 22.3 | 74.6 |
| 9 | 1.3 | 1.3 | 56.6 | 41.0 |
| 10 | NA | NA | NA | NA |
| 11 | 1.6 | 1.6 | 72.4 | 25.4 |
| 12 | NA | NA | NA | NA |

TABLE 10

| | Mehlich-3 ppm and Rating | | | | | |
|---|---|---|---|---|---|---|
| Example | S | B | Zn | Fe | Cu | Mn |
| 1 | 317 V | 1.6 M | 8.1 G | 30 G | 7.6 L | 16 L |
| 2 | 1698 V | 4.3 M | 36.2 V | 98 H | 35.5 H | 56 L |
| 3 | 1196 V | 3.0 H | 15.6 H | 60 H | 14.7 L | 21 L |
| 4 | 4962 V | 2.8 H | 11.3 H | 37 G | 8.4 L | 12 L |
| 5 | 3137 V | 1.2 M | 0.6 L | 4 L | 3.6 L | 1 L |
| 6 | 2617 V | 0.9 M | 0.3 L | 11 G | 5.1 L | 3 L |
| 7 | 7064 V | 33.3 V | 39.0 V | 144 V | 27.2 G | 46 L |
| 8 | 7849 V | 4.7 V | 52.2 V | 145 V | 48.2 G | 74 L |
| 9 | 5609 V | 15.4 V | 52.1 V | 106 V | 38.6 H | 69 L |
| 10 | NA | NA | NA | NA | NA | NA |
| 11 | 7089 V | 47.1 V | 30.4 V | 176 V | 18.3 G | 41 L |
| 12 | NA | NA | NA | NA | NA | NA |

As described above, a fluidized bed ash may be usable in artificial soils described herein. An exemplary fluidized bed ash composition is provided in the table below.

TABLE 11

| CHEMICAL BREAKDOWN | (Average wt. %) |
|---|---|
| CaO | 43.50 |
| SiO₂ | 16.80 |
| Al₂O₃ | 6.06 |
| Fe₂O₃ | 4.26 |
| Magnesium | 1.33 |
| K₂O | 0.68 |
| Na₂O | 0.06 |
| Pa₂O₅ | 0.11 |
| TiO₂ | 0.30 |
| SO₃ | 30.1 |
| Available CaO | 26.1 |

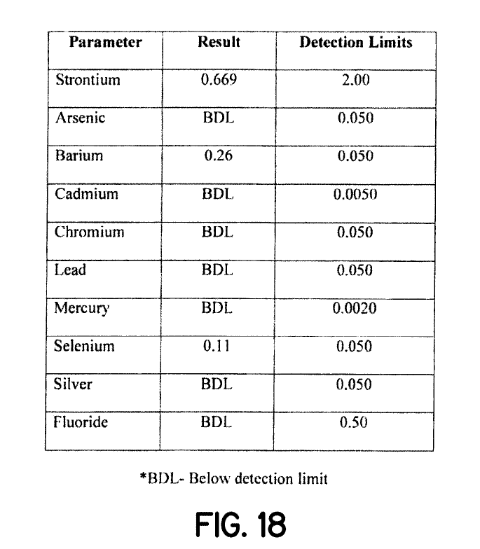

FIG. 18 includes a table of additional data regarding the fluidized bed ash of Table 11.

While the present invention has been illustrated by the description of one or more embodiments thereof, and while the embodiments have been described in considerable detail, they are not intended to restrict or in any way limit the scope of the appended claims to such detail. Additional advantages, products and applications will readily appear to those skilled in the art. The invention is therefore not limited to the specific details, representative method and illustrative examples shown and described. Accordingly, departures may be made from such details without departing from the scope of the general inventive concept.

What is claimed is:

1. An artificial soil for growing vegetation comprising:
a mixture of biosolids from a wastewater treatment plant, at least one of synthetic gypsum and a gypsum-depleted by-product from a process that produces gypsum separately from the gypsum-depleted by-product, and a calcium compound from at least one of a lime kiln dust, a fluidized bed ash, and a ball mill lime.

2. The artificial soil of claim 1, wherein the at least one of the lime kiln dust, the fluidized bed ash, and the ball mill lime is present in an amount sufficient to heat the mixture to at least about 132° F. following mixing.

3. The artificial soil of claim 1, wherein the mixture further includes at least one of silica and alumina.

4. The artificial soil of claim 3, wherein the at least one of silica and alumina is from the one of the lime kiln dust, the fluidized bed ash, and the ball mill lime.

5. The artificial soil of claim 1, further including hydrated lime.

6. The artificial soil of claim 1, wherein the gypsum-depleted by-product is from a process that produces the synthetic gypsum.

7. The artificial soil of claim 1, wherein the mixture includes at least about 1/9 by volume of biosolids.

8. The artificial soil of claim 1, wherein the mixture includes from about ⅛ to about ½ by volume of the calcium compound.

9. A method of manufacturing an artificial soil comprising:
mixing biosolids from a wastewater treatment plant with at least one of synthetic gypsum and a gypsum-depleted by-product from a process that produces gypsum separately from the gypsum-depleted by-product and at least one of a lime kiln dust, a fluidized bed ash, and a ball mill lime.

10. The method of claim 9, wherein during mixing, the at least one of the lime kiln dust, the fluidized bed ash, and the ball mill lime is added in an amount sufficient to heat the mixture to at least about 132° F.

11. The method of claim 9, wherein mixing further includes mixing hydrated lime with the biosolids.

12. The method of claim 9, wherein mixing the at least one of the gypsum and gypsum-depleted by-product with the biosolids is prior to mixing the biosolids with the at least one of the lime kiln dust, the fluidized bed ash, and the ball mill lime.

13. The method of claim 9, wherein the gypsum-depleted by-product is from a process that produces the synthetic gypsum.

14. The method of claim 9, wherein prior to mixing, the method comprises adding about 50 vol. % biosolids to about 50 vol. % of the synthetic gypsum.

15. The method of claim 9, wherein mixing includes adding from about 1/9 to about ½ by volume of the at least one of the lime kiln dust, the fluidized bed ash, and the ball mill lime in the mixture.

16. The method of claim 9, wherein mixing includes adding at least one of silica and alumina.

17. The method of claim 16, wherein addition of the at least one of silica and alumina is included in the at least one of the lime kiln dust, the fluidized bed ash, and the ball mill lime.
